(19) United States
(12) Patent Application Publication
(10) Pub. No.: US 2025/0299878 A1
(43) Pub. Date: Sep. 25, 2025

(54) COIL COMPONENT AND METHOD OF MANUFACTURING THE SAME

(71) Applicant: TDK Corporation, Tokyo (JP)

(72) Inventors: Shunya SUZUKI, Tokyo (JP); Toshinori MATSUURA, Tokyo (JP); Noriaki HAMACHI, Tokyo (JP); Kota OIKAWA, Tokyo (JP)

(73) Assignee: TDK Corporation, Tokyo (JP)

(21) Appl. No.: 19/080,082

(22) Filed: Mar. 14, 2025

(30) Foreign Application Priority Data
Mar. 25, 2024 (JP) 2024-048666

(51) Int. Cl. H01F 41/04; H01F 17/00

(52) U.S. Cl. CPC H01F 41/041; H01F 17/0013; H01F 2017/002

(57) ABSTRACT

In the coil component and the manufacturing method thereof, in the step of laminating the first layer and the second layer, the relative lamination position between the first layer and the second layer, that is, the relative position between the first coil conductor and the second coil conductor, may be determined as appropriate, thereby obtaining the desired inductance.

### CROSS-REFERENCE TO RELATED APPLICATIONS

This application is based upon and claims the benefit of priority from Japanese Patent Application No. 2024-48666, filed on 25 Mar. 2024, the entire content of which is incorporated herein by reference.

### TECHNICAL FIELD

The present disclosure relates to a coil component and a manufacturing method thereof.

### BACKGROUND

Japanese Patent Application Laid-Open No. H10-172831 discloses a coil component including a coil configured by being divided into multiple layers, in which a coil conductor as a part of the coil is provided in each layer. The ends of coil conductors adjacent vertically are connected via a through-hole conductor so that a current flows through the coil conductors in the same circumferential direction (for example, a clockwise direction in a plan view) when a voltage is applied to the coil component.

### SUMMARY

As a result of repeated studies on the inductance of the coil component, the inventors have newly found a technique for adjusting the inductance.

According to various aspects of the present disclosure, a coil component capable of adjusting inductance and a manufacturing method thereof are provided.

A manufacturing method of a coil component according to one aspect of the present disclosure is A manufacturing method of a coil component comprising a first layer and a second layer laminated with the first layer in a first direction, a first coil conductor configuring a part of a coil and including a first connecting portion is provided on a main surface of the first layer, a second coil conductor configuring the part of the coil and including a second connecting portion is provided on a main surface of the second layer, a through-hole conductor connecting the first connecting portion and the second connecting portion is provided through the second layer, and the first connecting portion is larger than the second connecting portion when viewed from the first direction. The manufacturing method includes a step of laminating the first layer and the second layer. A relative lamination position between the first layer and the second layer is determined according to a desired inductance of the coil in the step of laminating the first layer and the second layer.

In the above manufacturing method of the coil component, the inductance of the coil can be adjusted by determining the relative lamination position of the first layer and the second layer and performing lamination so as to obtain the desired inductance.

A coil component according to one aspect of the present disclosure includes a first layer and a second layer laminated with the first layer in a first direction, a first coil conductor configuring a part of a coil and including a first connecting portion is provided on a main surface of the first layer, a second coil conductor configuring the part of the coil and including a second connecting portion is provided on a main surface of the second layer, a through-hole conductor connecting the first connecting portion and the second connecting portion is provided through the second layer. When viewed from the first direction, the first connecting portion is larger than the second connecting portion when viewed from the first direction, and a contact area of the through-hole conductor with the second connecting portion is larger than a contact area of the through-hole conductor with the first connecting portion.

In the above coil component, the inductance of the coil can be adjusted by laminating the relative lamination position of the first layer and the second layer so as to obtain the desired inductance.

### BRIEF DESCRIPTION OF THE DRAWINGS

FIG. 1 is a schematic perspective view showing a coil component according to one embodiment.

FIG. 2 is a schematic exploded perspective view showing a configuration of a coil included in the coil component of FIG. 1.

FIG. 3 is a schematic plan view showing a configuration of a first coil conductor and a second coil conductor included in the coil component of FIG. 1.

FIG. 4 is a schematic cross-sectional view showing a laminated structure of the coil component of FIG. 1.

FIG. 5 is a diagram showing one step of the manufacturing method of the coil component of FIG. 1.

FIGS. 6A and 6B are diagrams showing one of the relative positional relationships between the first coil conductor and the second coil conductor.

FIGS. 7A and 7B are diagrams showing one of the relative positional relationships between the first coil conductor and the second coil conductor.

FIGS. 8A and 8B are diagrams showing the first coil conductor having a different shape.

FIGS. 9A to 9C are diagrams showing the first coil conductor having a different shape.

FIGS. 10A and 10B are diagrams showing the first coil conductor having a different shape.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

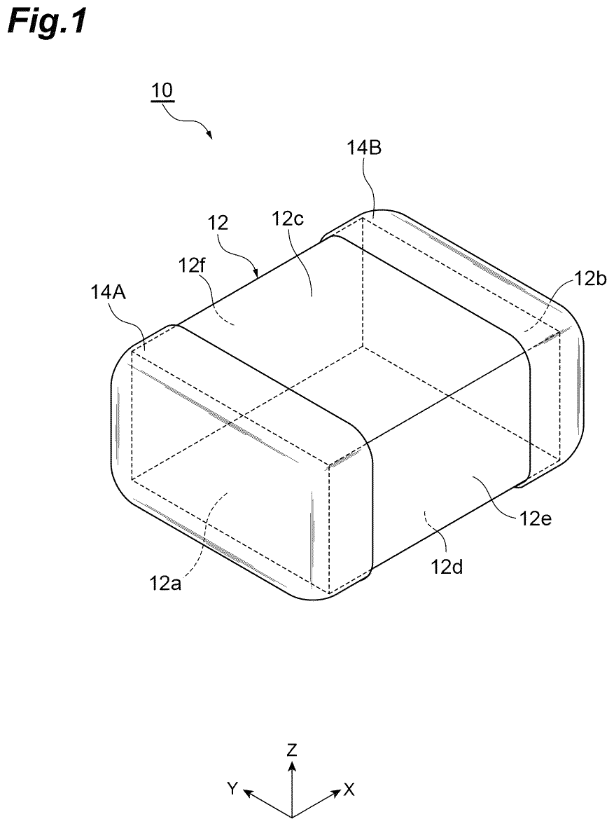

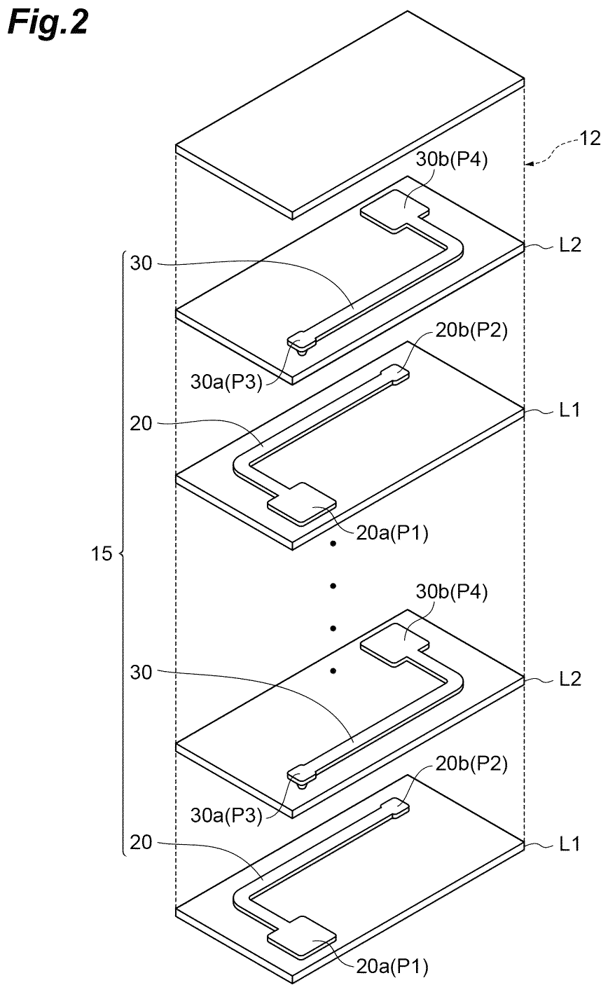

A structure of a coil component according to one embodiment will be described with reference to FIGS. 1 to 3. For convenience of explanation, XYZ coordinates are set as shown. That is, the thickness direction of the coil component is set as a Z-direction (first direction), the facing direction of the external terminal electrodes is set as an X-direction, and the direction orthogonal to the Z-direction and the X-direction is set as a Y-direction.

The coil component 10 according to the present embodiment is configured to include an element body 12, and a pair of external terminal electrodes 14A and 14B provided on the surface of the element body 12. In the present embodiment, the coil component 10 exhibits an outer shape of a rectangular parallelepiped shape.

The element body 12 has the outer shape of the rectangular parallelepipeded shape, a pair of end surface 12a and 12b facing in the X-direction, a pair of main surfaces 12c and 12d facing in the Z-direction, and a pair of side surfaces 12e and 12f facing in the Y-direction. The element body 12 has a laminated structure, and a plurality of layers are laminated in a lamination direction (the Z-direction).

A coil 15 having a coil axis parallel to the Z-direction is provided in the element body 12. The coil 15 is configured to include a plurality of coil conductors 20 and 30 provided in the interlayers. In the present embodiment, the coil 15 is configured to include first coil conductors 20 provided on the main surface of first layers L1 configuring the element body 12 and second coil conductors 30 provided on the main surface of second layers L2 configuring the element body 12. In the element body 12, the first layers L1 and the second layers L2 are alternately laminated, and the first coil conductors 20 on the first layers L1 and the second coil conductors 30 on the second layers L2 are connected through through-hole conductors 40 provided through the second layers L2. One end portion of the coil 15 is extracted to the end surface 12a of the element body 12 via an extracting conductor (not shown), and the other end portion of the coil 15 is extracted to the end surface 12b of the element body 12 via an extracting conductor (not shown).

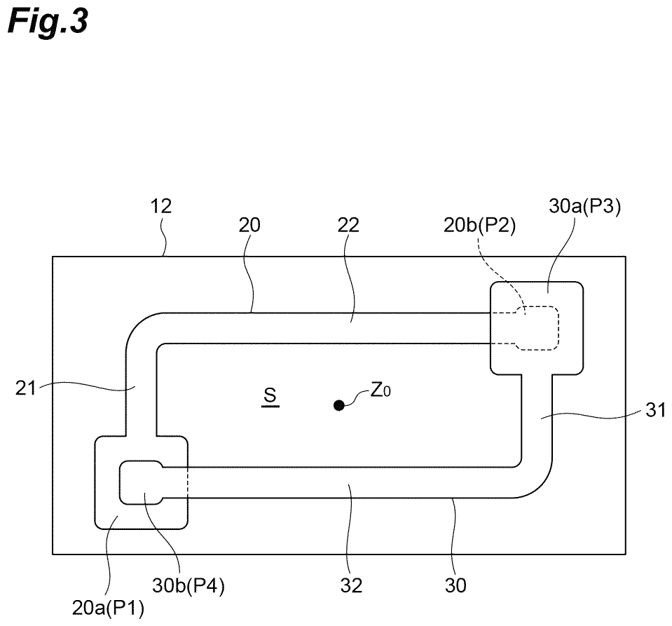

As shown in FIG. 3, the first coil conductor 20 and the second coil conductor 30 have L-shapes, and substantially the same shapes and the same dimension. When viewed from the Z-direction, the first coil conductor 20 and the second coil conductor 30 have a 180-degree rotational symmetry relationship with respect to a center Z₀ in the layers L1 and L2. The first coil conductor 20 and the second coil conductor 30 configure the outer shape of the coil 15 of the substantially rectangular shape when viewed from the Z-direction, and define an inner diameter S of the coil 15 of the substantially rectangular shape.

The first coil conductor 20 has a first line portion 21 extending along the X-direction and corresponding to the short side of the coil 15 and a second line portion 22 extending along the Y-direction and corresponding to the long side of the coil 15. The length of the second line portion 22 is longer than the length of the first line portion 21. The length of the second line portion 22 may be the same as the length of the first line portion 21, or may be shorter than the length of the first line portion 21. An end portion 20a of the first line portion 21 of the first coil conductor 20 is provided in the configuration of an electrode pad P1 (first connecting portion), and an end portion 20b of the second line portion 22 is provided in the configuration of an electrode pad P2 (third connecting portion). Similarly, the second coil conductor 30 has a first line portion 31 extending along the X-direction and corresponding to the short side of the coil 15 and a second line portion 32 extending along the Y-direction and corresponding to the long side of the coil 15. The length of the second line portion 32 is longer than the length of the first line portion 31. The length of the second line portion 32 may be the same as the length of the first line portion 31, or may be shorter than the length of the first line portion 31. An end portion 30a of the first line portion 31 of the second coil conductor 30 is provided in the configuration of an electrode pad P3, and an end portion 30b of the second line portion 32 is provided in the configuration of an electrode pad P4. In the present embodiment, when viewed from the lamination direction, each of the electrode pads P1 to P4 exhibits a rectangular shape (substantially square shape) configured with sides parallel to sides of the coil 15 having a rectangular shape, in particular, a rectangular shape in which all corners are rounded.

As shown in FIG. 3, the electrode pad P1 of the first coil conductor 20 overlaps with the electrode pad P4 of the second coil conductor 30 at a corner of the rectangle. The electrode pad P2 of the first coil conductor 20 overlaps with the electrode pad P3 of the second coil conductor 30 at another corner that is in a diagonal positional relationship with a corner where the electrode pad P1 of the first coil conductor 20 and the electrode pad P4 of the second coil conductor 30 overlap.

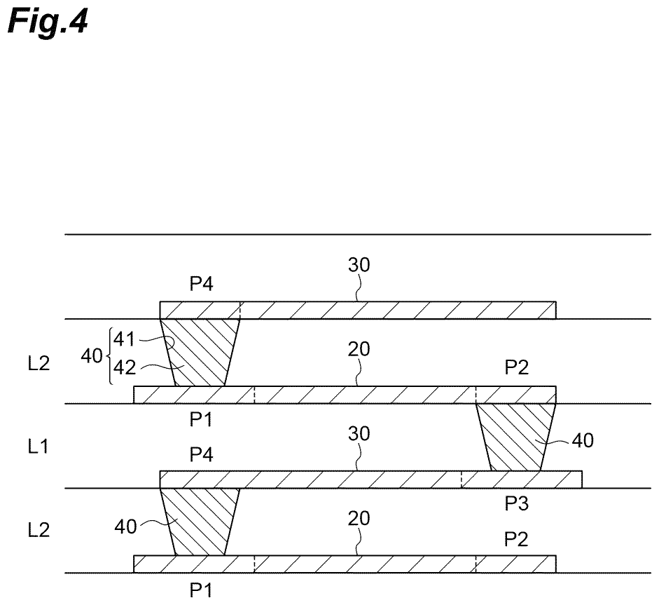

As shown in FIG. 4, the electrode pad P1 of the first coil conductor 20 and the electrode pad P4 of the second coil conductor 30 are interlayer-connected through the through-hole conductor 40 formed through a region of the second layer L2 corresponding to a formation region of the electrode pad P4. The through-hole conductor 40 includes a through hole 41 and a conductor 42 filling the through hole 41. In the present embodiment, an aperture of the through hole 41 on a main surface (upper surface in FIG. 4) side on which the second coil conductor 30 is provided differs in dimension from an aperture of the through hole 41 on another main surface (lower surface in FIG. 4) side. The inner surface of the through hole 41 is inclined so that the dimension of the aperture of the upper surface side is larger than the dimension of the aperture of the lower surface side. Specifically, the inner surface of the through hole 41 has a truncated cone shape, and the conductor 42 filling the through hole 41 also has a truncated cone shape. Therefore, when viewed from the lamination direction, the contact area between the through-hole conductor 40 and the electrode pad P4 is larger than the contact area between the through-hole conductor 40 and the electrode pad P1. The conductor 42 of the through-hole conductor 40 penetrating the second layer L2 and the electrode pad P4 of the second coil conductor 30 may be integrally formed.

As shown in FIG. 3, when viewed from the lamination direction, the dimension of the electrode pad P1 of the first coil conductor 20 is designed to be larger than the dimension of the electrode pad P4 of the second coil conductor 30. Specifically, when viewed from the lamination direction, the length of all four sides of the outer shape of the rectangular shape of the electrode pad P1 of the first coil conductor 20 is longer than the length of all four sides of the outer shape of the rectangular shape of the electrode pad P4 of the second coil conductor 30. The area of the electrode pad P1 of the first coil conductor 20 is larger than the area of the electrode pad P4 of the second coil conductor 30. The electrode pad P4 of the second coil conductor 30 is overlapped on the electrode pad P1 so that the formation region of the electrode pad P4 is wholly included in the formation region of the electrode pad P1 of the first coil conductor 20. The electrode pad P1 of the first coil conductor 20 is considerably beyond the rectangular annular formation region of the coil 15 when viewed from the lamination direction. As long as the electrode pad P1 and the electrode pad P4 can be electrically connected via the through-hole conductor 40, only a part of the electrode pad P4 may be included in the formation region of the electrode pad P1.

Similarly, the electrode pad P2 of the first coil conductor 20 and the electrode pad P3 of the second coil conductor 30 are interlayer-connected through the through-hole conductor 40 formed through a region of the first layer L1 corresponding to a formation region of the electrode pad P2. When viewed from the lamination direction, the contact area between the through-hole conductor 40 and the electrode pad P2 is larger than the contact area between the through-hole conductor 40 and the electrode pad P3. The conductor 42 of the through-hole conductor 40 provided through the first layer L1 and the electrode pad P2 of the first coil conductor 20 may be integrally formed.

As shown in FIG. 3, when viewed from the lamination direction, the dimension of the electrode pad P3 of the second coil conductor 30 is designed to be larger than the dimension of the electrode pad P2 of the first coil conductor 20. Specifically, when viewed from the lamination direction, the length of all four sides of the outer shape of the rectangular shape of the electrode pad P3 of the second coil conductor 30 is longer than the length of all four sides of the outer shape of the rectangular shape of the electrode pad P2 of the first coil conductor 20. The area of the electrode pad P3 of the second coil conductor 30 is larger than the area of the electrode pad P2 of the first coil conductor 20. The electrode pad P2 of the first coil conductor 20 is overlapped on the electrode pad P3 so that the formation region of the electrode pad P2 is wholly included in the formation region of the electrode pad P3 of the first coil conductor 30. The electrode pad P3 of the second coil conductor 30 is considerably beyond the rectangular annular formation region of the coil 15 when viewed from the lamination direction. As long as the electrode pad P2 and the electrode pad P3 can be electrically connected via the through-hole conductor 40, only a part of the electrode pad P2 may be included in the formation region of the electrode pad P3.

In the present embodiment, since the first coil conductor 20 and the second coil conductor 30 substantially have the same shape and the same dimension, the dimension of the electrode pad P1 of the first coil conductor 20 is larger than the dimension of the electrode pad P2, and the dimension of the electrode pad P3 of the second coil conductor 30 is larger than the dimension of the electrode pad P4.

The pair of the external terminal electrodes 14A and 14B are provided in the pair of the end surfaces 12a and 12b, respectively. The external terminal electrodes 14A and 14B may be configured by one layer or multiple electrode layers. In the present embodiment, the external terminal electrode 14A integrally covers the entire region of the end surface 12a, and the main surfaces 12c and 12d and the side surfaces 12e and 12f of the region adjacent to the end surface 12a. The external terminal electrode 14A is electrically connected to one end portion of the coil 15 exposed to the end surface 12a of the element body 12. Similarly, the external terminal electrode 14B integrally covers the entire region of the end surface 12b, and the main surfaces 12c and 12d and the side surfaces 12e and 12f of the region adjacent to the end surface 12b. The external terminal electrode 14B is electrically connected to the other end portion of the coil 15 exposed to the end surface 12b of the element body 12.

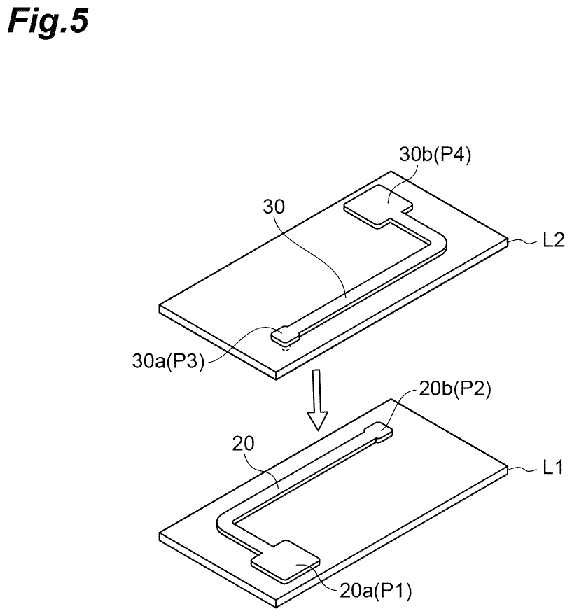

Next, the manufacturing method of the above the coil component 10 will be described with reference to FIG. 5, 6A, 6B, 7A, and 7B.

Firstly, sheets to be first layers L1 and sheets to be the second layers L2 configuring a part of the element body 12 are prepared. Each of the sheets to be the first layers L1 is provided with one or more the first coil conductors 20. In the case that the first coil conductors 20 are provided, the first coil conductors 20 may be arranged in a matrix shape and provided at a high density. In the sheet to be the first layer L1, the through-hole conductor 40 is provided through a region corresponding to the formation region of the electrode pad P2 of the first coil conductor 20. Similarly, each of the sheets to be the second layers L2 is provided with one or more the second coil conductor 30. In the case that the second coil conductors 30 are provided, the second coil conductors 30 may be arranged in a matrix shape and provided at a high density. In the sheet to be the second layer L2, the through-hole conductor 40 is provided through a region corresponding to the formation region of the electrode pad P3 of the second coil conductor 30.

Then, the sheet to be the first layer L1 and the sheet to be the second layer L2 are laminated. For convenience of the description, FIG. 5 shows an appearance in which the first layer L1 and the second layer L2 are laminated, not a configuration of a sheet. Although the second layer L2 is stacked on the first layer L1 from the upper side in FIG. 5, the first layer L1 may is stacked on the second layer L2 from the lower side.

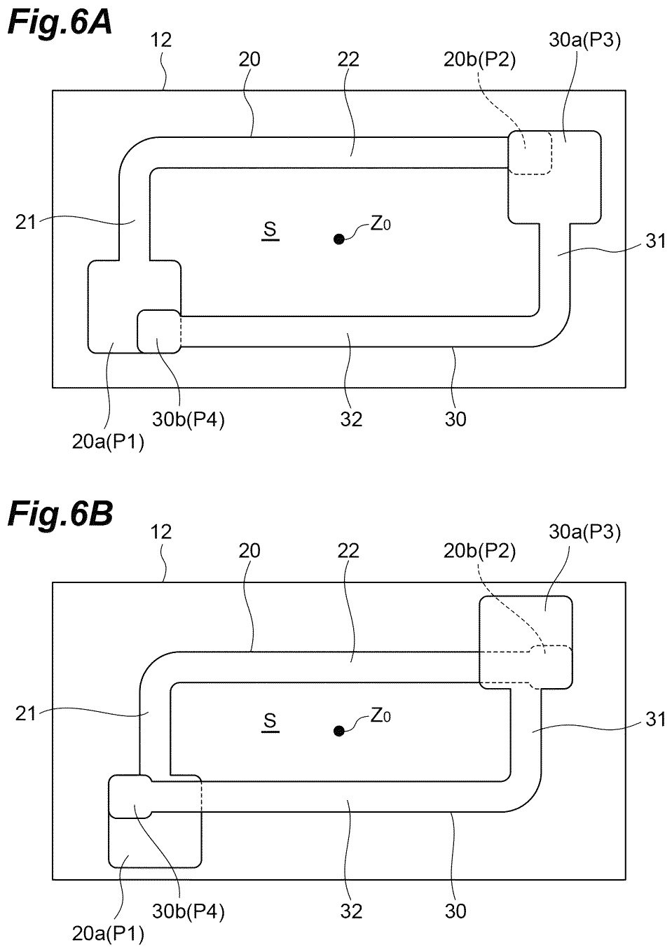

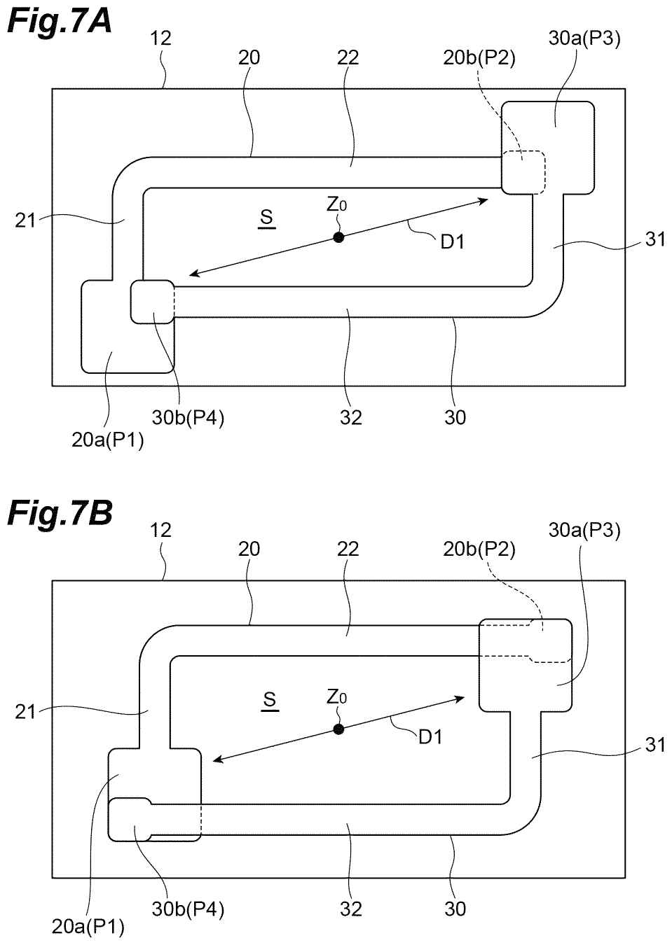

The first layer L1 and the second layer L2 can be laminated in various relative positions as shown in FIGS. 6A, 6B, 7A, and 7B.

In the relative position between the first coil conductor 20 and the second coil conductor 30 shown in FIG. 6A, the inner diameter S of the coil 15 is the maximum. In this case, the first line portion 21 of the first coil conductor 20 and the first line portion 31 of the second coil conductor 30 are farthest from each other in the X-direction, and the second line portion 22 of the first coil conductor 20 and the second line portion 32 of the second coil conductor 30 are farthest from each other in the Y-direction. The electrode pad P4 of the second coil conductor 30 is positioned at the corner of the formation region of the electrode pad P1 of the first coil conductor 20 (the lower right corner in FIG. 6A), and the electrode pad P2 of the first coil conductor 20 is positioned at the corner of the formation region of the electrode pad P3 of the second coil conductor 30 (the upper left corner in FIG. 6A). In the relative position between the first coil conductor 20 and the second coil conductor 30 shown in FIG. 6B, the inner diameter S of the coil 15 is the minimum. In this case, the first line portion 21 of the first coil conductor 20 and the first line portion 31 of the second coil conductor 30 are closest to each other in the X-direction, and the second line portion 22 of the first coil conductor 20 and the second line portion 32 of the second coil conductor 30 are closest to each other in the Y-direction. The electrode pad P4 of the second coil conductor 30 is positioned at the corner of the formation region of the electrode pad P1 of the first coil conductor 20 (the upper left corner in FIG. 6B), and the electrode pad P2 of the first coil conductor 20 is positioned at the corner of the formation region of the electrode pad P3 of the second coil conductor 30 (the lower right corner in FIG. 6B).

FIGS. 7A and 7B show aspects in which the relative positions of the first coil conductor 20 and the second coil conductor 30 are changed in a direction D1, in which the direction D1 is a diagonal direction facing a corner where the electrode pad P1 of the first coil conductor 20 and the electrode pad P4 of the second coil conductor 30 overlap and a corner where the electrode pad P2 of the first coil conductor 20 and the electrode pad P3 of the second coil conductor 30 overlap. In the relative position between the first coil conductor 20 and the second coil conductor 30 shown in FIG. 7A, the first line portion 21 of the first coil conductor 20 and the first line portion 31 of the second coil conductor 30 are farthest from each other in the X-direction, and the second line portion 22 of the first coil conductor 20 and the second line portion 32 of the second coil conductor 30 are closest to each other in the Y-direction. In the relative position between the first coil conductor 20 and the second coil conductor 30 shown in FIG. 7B, the first line portion 21 of the first coil conductor 20 and the first line portion 31 of the second coil conductor 30 are closest to each other in the X-direction, and the second line portion 22 of the first coil conductor 20 and the second line portion 32 of the second coil conductor 30 are farthest from each other in the Y-direction.

In the case of laminating the first layer L1 and the second layer L2, as shown in FIG. 3, the relative position between the first coil conductor 20 and the second coil conductor 30 may be determined so that the centers of the electrode pads P1 to P4 overlap each other.

As described above, the first layer L1 and the second layer L2 can be laminated in various relative positions, and the inner diameter S of the coil 15 is determined according to the relative position. The inductance value of the coil component 10 changes according to the inner diameter S of the coil 15, and the inductance value increases as the inner diameter S of the coil 15 increases. For example, in the configuration shown in FIG. 6A, since the inner diameter S of the coil 15 is maximum, the inductance of the coil 15 can be increased as compared with the configuration shown in FIG. 6B in which the inner diameter S of the coil 15 is minimum. There is almost no difference in the inner diameter S of the coil 15 between the configuration shown in FIG. 7A and the configuration shown in FIG. 7B, and the inductances of the same degree can be realized. However, the Q value, which is one of the coil characteristics, is different between the configuration shown in FIG. 7A and the configuration shown in FIG. 7B, and the configuration shown in FIG. 7A and the configuration shown in FIG. 7B can be adopted in view of the Q value.

All of the first layers L1 and all of the second layers L2 included in the element body 12 may be laminated in the same relative positional relationship. A part of the first layers L1 and a part of the second layers L2 included in the element body 12 may be laminated in different relative positional relationship.

As described above, in the step of laminating the first layer L1 and the second layer L2, the relative lamination position between the first layer L1 and the second layer L2, i.e., the relative position between the first coil conductor 20 and the second coil conductor 30, can be determined as appropriate, thereby obtaining the desired inductance.

In the case that all the first coil conductors 20 included in the element body 12 of the coil component 10 have the same shape, the same mask for patterning can be used. In the case that all the second coil conductors 30 included in the element body of the coil component 10 have the same shape, the same mask for patterning can be used. As shown in FIG. 3, in the case that the first coil conductor 20 and the second coil conductor 30 have the rotational symmetry relationship, the second coil conductor 30 can be obtained only by rotating the first coil conductor 20, so that there is no need to separately prepare the mask for forming the first coil conductor 20 and the second coil conductor 30, and the steps and the costs for manufacturing the coil component 10 can be reduced.

In the coil component 10, when viewed from the lamination direction, the coil 15 has a rectangular annular shape, the electrode pads P1 to P4 of the first coil conductor 20 and the second coil conductor 30 are positioned at the corners of the rectangle, and the electrode pads P1 to P4 are overlapped and connected at the position of the corner. In the case that the electrode pads P1 to P4 are positioned at the corner of the rectangle, the pair of the electrode pads Pland P4 and the pair of the electrode pads P2 and P3 have a diagonal positional relationship, and the maximum separation distance in the rectangle may be obtained. Therefore, a short circuit between the electrode pads P1 to P4 in the same layer and a floating capacity caused by the facing the electrode pads P1 to P4 in the lamination direction (for example, the facing of the electrode pad P1 and the larger electrode pad P4) are effectively suppressed.

In the coil component 10, as shown in FIGS. 3, 6A, 6B, 7A, and 7B, the first coil conductor 20 and the second coil conductor 30 can take various relative positions. As shown in FIGS. 7A and 7B, in the case that the first coil conductor 20 and the second coil conductor 30 are shifted to the diagonal direction D1 (that is, a direction connecting the electrode pad P1 and the electrode pad P2 when viewed from the lamination direction), the inner diameter S of the coil 15 does not change. The inner diameter S of the coil 15 can be changed by shifting the relative position between the first coil conductor 20 and the second coil conductor 30 in a direction intersecting with the diagonal direction D1 (for example, a direction orthogonal to the diagonal direction D1).

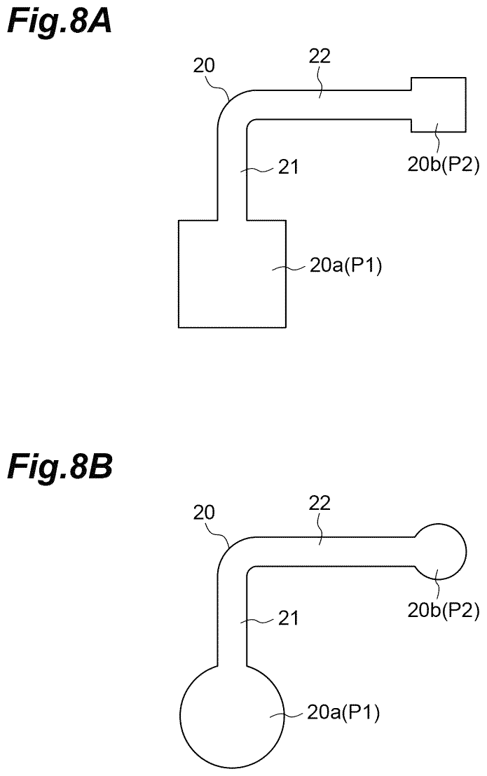

The shapes of the first coil conductor 20 and the second coil conductor 30 are not limited to the above shape, and may be shapes as shown in FIGS. 8A, 8B, 9A to 9C, 10A, and 10B. In FIGS. 8A, 8B, 9A to 9C, 10A, and 10B, only the shape of the first coil conductor 20 is described for simple description, but the shape of the second coil conductor 30 may be changed similarly.

The shape of the first coil conductor 20 shown in FIG. 8A differs from the shape of the first coil conductor 20 above, and the shapes of the electrode pads P1 and P2 in FIG. 8A are not a rectangle in which all corners are rounded, but a rectangle in which all corners are not rounded and are right angles. The shape of the first coil conductor 20 shown in FIG. 8B differs from the shape of the first coil conductor 20 above, the shapes of the electrode pads P1 and P2 in FIG. 8B are circular rather than rectangle.

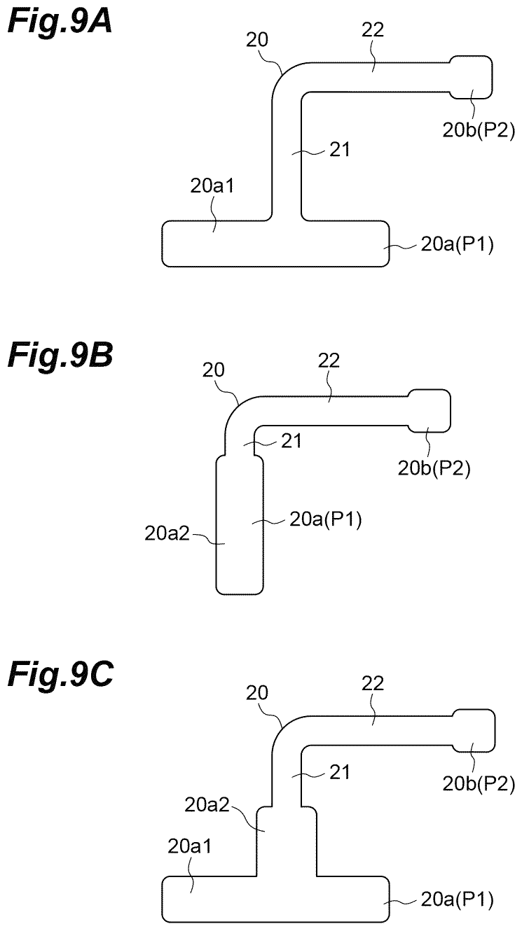

The shape of the first coil conductor 20 shown in FIG. 9A differs from the shape of the first coil conductor 20 above, and the shape of the electrode pad P1 in FIG. 9A is a wide width I-shape as a pad portion 20al extending along the Y-direction (i.e., the facing direction of the end surfaces 12a and 12b of the element body 12). In this case, in the step of laminating the first layer L1 and the second layer L2, the relative positional relationship of the first coil conductor 20 and the second coil conductor 30 with respect to the Y-direction may be adjusted. In adjusting the relative positional relationship between the first coil conductor 20 and the second coil conductor 30 only with respect to the Y-direction, the electrode pad P1 in FIG. 9A can reduce the pad material as compared with the electrode pad P1 having the larger square shape above. In addition, by reducing the size of the electrode pad P1, the electrode pad P1 is less likely to obstruct the magnetic flux generated in the inner diameter S of the coil 15, and the inductance increases.

The shape of the first coil conductor 20 shown in FIG. 9B differs from the shape of the first coil conductor 20 above, and the shape of the electrode pad P1 in FIG. 9B is a wide width I-shape as a pad portion 20a2 extending along the X-direction (i.e., the facing direction of the side surfaces 12e and 12f of the element body 12). In this case, in the step of laminating the first layer L1 and the second layer L2, the relative positional relationship of the first coil conductor 20 and the second coil conductor 30 with respect to the X-direction may be adjusted. In adjusting the relative positional relationship between the first coil conductor 20 and the second coil conductor 30 only with respect to the X-direction, the electrode pad P1 in FIG. 9B can reduce the pad material as compared with the electrode pad P1 having the larger square shape above. In addition, by reducing the size of the electrode pad P1, the electrode pad P1 is less likely to obstruct the magnetic flux generated in the inner diameter S of the coil 15, and the inductance increases.

The shape of the first coil conductor 20 shown in FIG. 9C differs from the shape of the first coil conductor 20 above, the electrode pad P1 in FIG. 9C has a T shape including the above pad portions 20a1 and 20a2 with wide widths. In this case, in the step of laminating the first layer L1 and the second layer L2, the relative positional relationship of the first coil conductor 20 and the second coil conductor 30 with respect to the X-direction and the Y-direction may be adjusted. In adjusting the relative positional relationship between the first coil conductor 20 and the second coil conductor 30 only with respect to the X-direction and the Y-direction, the electrode pad P1 in FIG. 9C can reduce the pad material as compared with the electrode pad P1 having the larger square shape above. In addition, by reducing the size of the electrode pad P1, the electrode pad P1 is less likely to obstruct the magnetic flux generated in the inner diameter S of the coil 15, and the inductance increases.

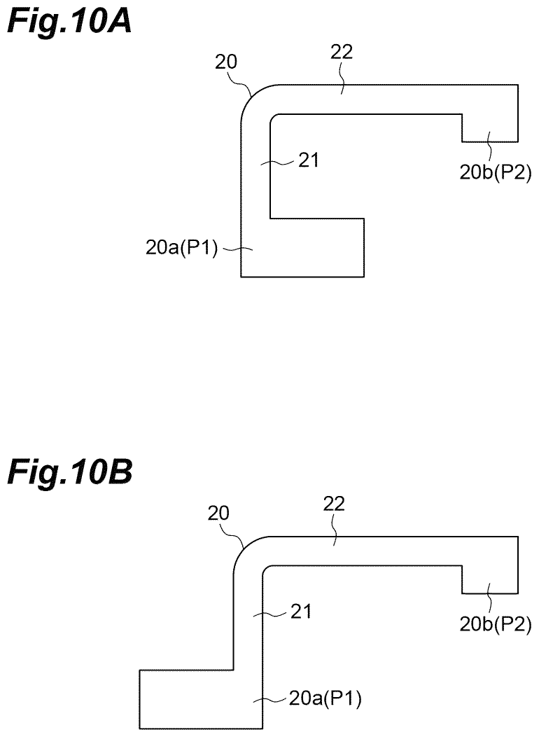

The shape of the first coil conductor 20 shown in FIG. 10A differs from the shape of the first coil conductor 20 above, the shapes of the electrode pads P1 and P2 do not protrude into the outer shape side of the coil 15 when viewed from the Z-direction. Specifically, the electrode pad P1 does not protrude from the extension line of the outer shape of the coil 15 defined by the first line portion 21, and the electrode pad P2 does not protrude from the extension line of the outer shape of the coil 15 defined by the second line portion 22. The shape of the first coil conductor 20 shown in FIG. 10B differs from the shape of the first coil conductor 20 above, only the shape of the electrode pad P2 does not protrude to the outer shape side of the coil 15 when viewed from the Z-direction. Specifically, the electrode pad P2 does not protrude from the extension line of the outer shape of the coil 15 defined by the second line portion 22. When viewed from the Z-direction, each of the electrode pads P1 and P2 may have a shape that protrudes to the outer shape side of the coil 15 or may have a shape that does not protrude.

What is claimed is:

1. A manufacturing method of a coil component comprising a first layer and a second layer laminated with the first layer in a first direction, a first coil conductor configuring a part of a coil and including a first connecting portion is provided on a main surface of the first layer, a second coil conductor configuring the part of the coil and including a second connecting portion is provided on a main surface of the second layer, a through-hole conductor connecting the first connecting portion and the second connecting portion is provided through the second layer, and the first connecting portion is larger than the second connecting portion when viewed from the first direction,
wherein the manufacturing method includes a step of laminating the first layer and the second layer,
wherein a relative lamination position between the first layer and the second layer is determined according to a desired inductance of the coil in the step of laminating the first layer and the second layer.

2. The manufacturing method of the coil component according to claim 1, wherein the first coil conductor further includes a third connecting portion, and the third connecting portion is smaller than the first connecting portion when viewed from the first direction.

3. The manufacturing method of a coil component according to claim 1, wherein the coil having a rectangle shape is defined by the first coil conductor and the second coil conductor when viewed from the first direction, and the first connecting portion and the second connecting portion are arranged at corners of the rectangle.

4. The manufacturing method of the coil component according to claim 1, wherein a contact area of the through-hole conductor with the second connecting portion is larger than a contact area of the through-hole conductor with the first connecting portion when viewed from the first direction.

5. The manufacturing method of the coil component according to claim 1, wherein a part of least one of the first connecting portion and the second connecting portion is beyond a formation region of the coil when viewed from the first direction.

6. The manufacturing method of the coil component according to claim 1, wherein the coil component comprises a plurality of the first coil conductors and a plurality of the second coil conductors.

7. The manufacturing method of the coil component according to claim 1, wherein the shape of the first coil conductor and the shape of the second coil conductor have rotational symmetry when viewed from the first direction.

8. The manufacturing method of the coil component according to claim 2, wherein in the step of laminating the first layer and the second layer, the relative lamination position of the first layer and the second layer is determined with respect to a direction intersecting a direction connecting the first connecting portion and the third connecting portion when viewed from the first direction.

9. A coil component comprising an element body comprising a first layer and a second layer laminated with the first layer in a first direction, a first coil conductor configuring a part of a coil and including a first connecting portion is provided on a main surface of the first layer, a second coil conductor configuring the part of the coil and including a second connecting portion is provided on a main surface of the second layer, a through-hole conductor connecting the first connecting portion and the second connecting portion is provided through the second layer,
wherein, when viewed from the first direction, the first connecting portion is larger than the second connecting portion when viewed from the first direction, and a contact area of the through-hole conductor with the second connecting portion is larger than a contact area of the through-hole conductor with the first connecting portion.
